(19) United States
(12) Patent Application Publication
(10) Pub. No.: US 2016/0163314 A1
(43) Pub. Date: Jun. 9, 2016

(54) DIALOG MANAGEMENT SYSTEM AND DIALOG MANAGEMENT METHOD

(71) Applicant: MITSUBISHI ELECTRIC CORPORATION, Tokyo (JP)

(72) Inventors: Yoichi FUJII, Tokyo (JP); Jun ISHII, Tokyo (JP)

(73) Assignee: MITSUBISHI ELECTRIC CORPORATION, Tokyo (JP)

(21) Appl. No.: 14/907,719

(22) PCT Filed: Aug. 6, 2014
(86) PCT No.: PCT/JP2014/070768

§ 371 Date: Jan. 26, 2016

(30) Foreign Application Priority Data
Nov. 25, 2013 (JP) 2013-242944

(51) Int. Cl. G10L 15/22; G10L 13/027; G06F 17/27; G10L 15/18; G10L 15/26

(52) U.S. Cl. CPC G10L 15/22; G10L 15/1815; G10L 15/265; G06F 17/2755; G10L 13/027; G10L 15/1822; G10L 2015/223

(57) ABSTRACT

An intention estimated-weight determination processor 9 determines an intention estimated weight on the basis of an intention hierarchical graphic data 8 and an activated intention. A transfer node determination processor 10 determines an intention to be newly activated through transition, after correcting an intention estimation result according to the intention estimated weight. A dialog turn generator 13 generates a turn of dialog from the activated intention. A dialog management unit 2 controls, when a new input is provided due to the turn of dialog, at least one process among processes performed by an intention estimation processor 7, the intention estimated-weight determination processor 9, the transition node determination processor 10 and the dialog turn generator 13, followed by repeating that controlling, to thereby finally execute a setup command.

### TECHNICAL FIELD

The present invention relates to a dialog management system and a dialog management method for performing a dialog based on an input natural language to thereby execute a command matched to a user's intention.

### BACKGROUND ART

In recent years, attention has been paid to a method in which a language spoken by a person is inputted by speech, and using its recognition result, an operation is executed. This technology, which is applied to in speech interface in mobile phones and car-navigation systems, is that in which, as a basic method, an estimated speech recognition result has been associated with an operation beforehand by a system and the operation is executed when a speech recognition result is the estimated one. According to this method, in comparison with the conventional manual operation, an operation can be directly executed through phonetic utterance, and thus, this method serves effectively as a short-cut function. At the same time, the user is required to speak a language that the system is waiting for in order to execute the operation, so that, as the functions to be addressed by the system increase, the languages having to be kept in mind increase. Further, among the users, a few of them use the system after fully understanding its operation manual, and accordingly, the users generally do not understand how to talk what language for an operation, thus causing a problem that, actually, they cannot make an operation other than that of the function kept in their mind, through speech.

In this respect, as conventional arts having been improved in that matter, and as methods for accomplishing a purpose even if the user does not keep in mind a command for accomplishing the purpose, there are disclosed methods in which a system interactively induce so that the purpose is led to be accomplished. As one of the methods for accomplishment, there is a method in which a dialog scenario has been beforehand created in a tree structure, and a tracing is made from the root of the tree structure through intermediate nodes (hereinafter, “transition occurs on the tree structure” is expressed as “node is activated”), so that, at the time of reaching a terminal node, the user accomplishes the purpose. What route to be traced in the tree structure of the dialog scenario is determined based on a keyword held at each node in the tree structure and depending on what keyword is included during speaking of the user for a transition destination of a currently-activated intention.

Furthermore, according to a technology described, for example, in Patent Document 1, there is provided a plurality of such scenarios and the scenarios each hold a plurality of keywords by which that scenario is characterized, so that it is determined what scenario is to be selected for promoting dialog, based on an initial utterance of the user. Further, there is disclosed a method of changing the subject of conversation, that selects, when no uttered content by the user is matched to the transition destination in a tree structure related to a currently-proceeding scenario, another scenario on the basis of the plurality of keywords given to the plurality of scenarios, followed by promoting dialog from the root.

### CITATION LIST

### Patent Document

Patent Document 1: Japanese Patent Application Laid-open No. 2008-170817

### SUMMARY OF THE INVENTION

### Problems to be Solved by the Invention

The conventional dialog management systems are configured as described above, and thus allow to select a new scenario if the transition is unable. However, for example, in the case where an expression in a scenario in a tree structure created based on a function in design of the system is different to an expression that represents the function and is expected by the user, and thus, during dialog using the scenario in a tree structure after selection of the scenario, when a content uttered by the user is out of that expected by the scenario, this results in, on the assumption that there is possibly another scenario, selection of another scenario that is probable from the uttered content. If the uttered content is ambiguous, the scenario in progress is preferentially selected, so that there is a problem that even if another scenario is more probable, transition is not made thereto. Further, according to the conventional methods, it is unable to actively change the scenario itself, and thus, there is a problem that, when a scenario in a tree structure created based on a function in design of the system is different to a functional structure expected by the user, or when the user misunderstands the function, it is unable to customize the scenario in a tree structure.

This invention has been made to solve the problems as described above, and an object thereof is to provide a dialog control system that can perform an appropriate transition even for an unexpected input, to thereby execute an appropriate command.

### Means for Solving the Problems

A dialog management system according to the invention comprises: an intention estimation processor that, based on data provided by converting an input in a natural language into a morpheme string, estimates an intention of the input; an intention estimated-weight determination processor that, based on data in which intentions are arranged in a hierarchical structure and based on the intention thereamong being activated at a given object time, determines an intention estimated weight of the intention estimated by the intention estimation processor; a transition node determination processor that determines an intention to be newly activated through transition, after correcting an estimation result by the intention estimation processor according to the intention estimated weight determined by the intention estimated-weight determination processor; a dialog turn generator that generates a turn of dialog from one or plural intentions activated by the transition node determination processor; and a dialog manager that, when a new input in the natural language is provided due to the turn of dialog generated by the dialog turn generator, controls at least one process among processes performed by the intention estimation processor, the intention estimated-weight determination processor, the transition node determination processor and the dialog turn generator, followed by repeating that controlling, to thereby finally execute a setup command.

### Effect of the Invention

The dialog management system of the invention is configured to determine the intention estimated weight of the estimated intention, to thereby determine an intention to be newly activated through transition, after correcting the intention estimation result according to the intention estimated weight. Thus, even for an unexpected input, an appropriate transition is performed and thus an appropriate command can be executed.

### BRIEF DESCRIPTION OF THE DRAWINGS

FIG. 1 is a configuration diagram showing a dialog management system according to Embodiment 1 of the invention.

FIG. 2 is an illustration diagram showing an example of intention hierarchical data in the dialog management system according to Embodiment 1 of the invention.

FIG. 3 is an illustration diagram showing a dialog example by the dialog management system according to Embodiment 1 of the invention.

FIG. 4 is an illustration diagram showing transitions of intentions in dialog by the dialog management system according to Embodiment 1 of the invention.

FIG. 5 is an illustration diagram showing intention estimation results by the dialog management system according to Embodiment 1 of the invention.

FIG. 6 is an illustration diagram showing dialog scenario data in the dialog management system according to Embodiment 1 of the invention.

FIG. 7 is an illustration diagram showing dialog history data in the dialog management system according to Embodiment 1 of the invention.

FIG. 8 is a flowchart showing a flow of dialog by the dialog management system according to Embodiment 1 of the invention.

FIG. 9 is a flowchart showing a flow in a generation process of a dialog turn by the dialog management system according to Embodiment 1 of the invention.

FIG. 10 is a configuration diagram showing a dialog management system according to Embodiment 2 of the invention.

FIG. 11 is an illustration diagram showing a dialog example by the dialog management system according to Embodiment 2 of the invention.

FIG. 12 is an illustration diagram showing intention estimation results by the dialog management system according to Embodiment 2 of the invention.

FIG. 13 is an illustration diagram showing command history data in the dialog management system according to Embodiment 2 of the invention.

FIG. 14 is a flowchart showing a flow in an addition process to the command history data by the dialog management system according to Embodiment 2 of the invention.

FIG. 15 is a flowchart showing a process flow for determining whether or not to make confirmation to a user, by the dialog management system according to Embodiment 2 of the invention.

FIG. 16 is a configuration diagram showing a dialog management system according to Embodiment 3 of the invention.

FIG. 17 is an illustration diagram showing a dialog example by the dialog management system according to Embodiment 3 of the invention.

FIG. 18 is an illustration diagram showing intention estimation results by the dialog management system according to Embodiment 3 of the invention.

FIG. 19 is an illustration diagram showing additional transition-link data in the dialog management system according to Embodiment 3 of the invention.

FIG. 20 is a flowchart showing a flow in a changing process of an additional transition link by the dialog management system according to Embodiment 3 of the invention.

FIG. 21 is an illustration diagram showing intention hierarchical data after change, by the dialog management system according to Embodiment 3 of the invention.

### MODES FOR CARRYING OUT THE INVENTION

Hereinafter, for illustrating the invention in more detail, embodiments for carrying out the invention will be described according to the accompanying drawings.

### Embodiment 1

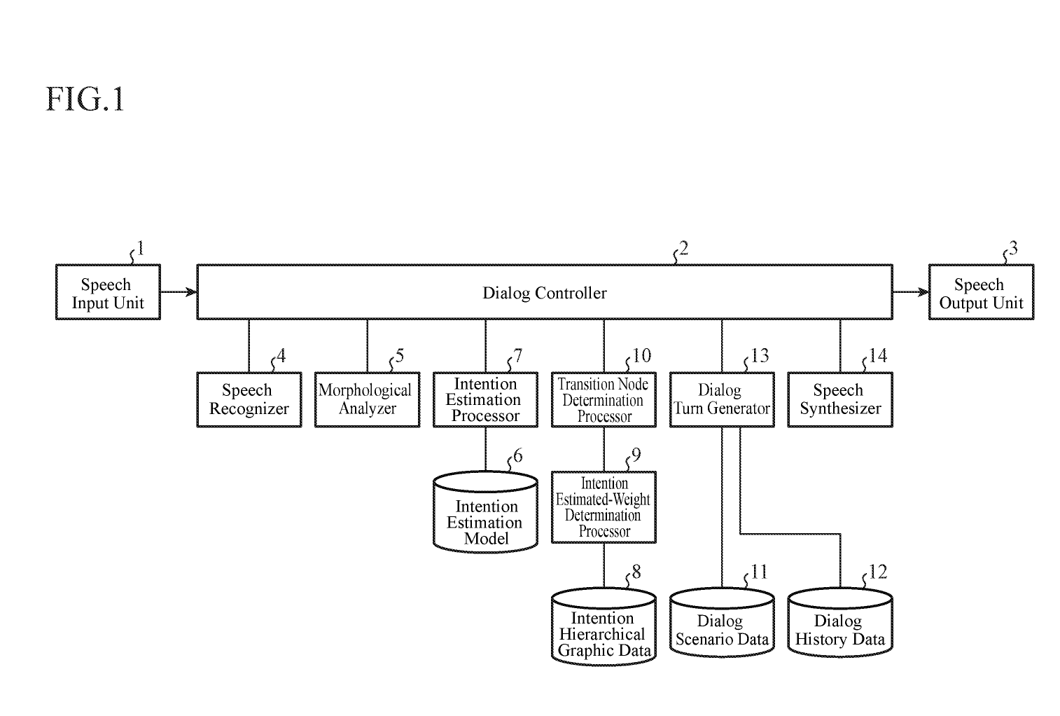

FIG. 1 is a configuration diagram showing a dialog management system according to Embodiment 1 of the invention.

The dialog management system shown in FIG. 1 includes: a speech input unit 1; a dialog management unit 2; a speech output unit 3; a speech recognizer 4; a morphological analyzer 5; an intention estimation model 6; an intention estimation processor 7; an intention hierarchical graphic data 8; an intention estimated-weight determination processor 9; a transition node determination processor 10; a dialog scenario data 11; a dialog history data 12; a dialog turn generator 13; and a speech synthesizer 14.

The speech input unit 1 is an input unit in the dialog management system that receives an input by speech. The dialog management unit 2 is a management unit that controls the speech recognizer 4 to the speech synthesizer 14 so as to promote dialog and thereby to finally execute a command allocated to an intention. The speech output unit 3 is an output unit in the dialog management system that performs outputting by speech. The speech recognizer 4 is a processing unit that recognizes the speech inputted through the speech input unit 1 and converts it into a text. The morphological analyzer 5 is a processing unit that divides a recognition result from recognition by the speech recognizer 4 into morphemes. The intention estimation model 6 is data of an intention estimation model for estimating an intention using a morphological analysis result from analysis by the morphological analyzer 5. The intention estimation processor 7 is a processing unit that inputs the morphological analysis result from analysis by the morphological analyzer 5 and uses the intention estimation model 6, to thereby output an intention estimation result. The intention estimation processor outputs a set of an intention and a score indicative of probability of that intention, in a form of a list.

An intention is represented, for example, in such a form of “<main intention> [<slot name>=<Slot value> . . . ]”. In a specific example, it may be represented as “Destination Point Setting [Facility=?]”, “Destination Point Setting [Facility=$Facility$ (=‘oo’ Ramen)]”, or the like [a specific POI (Point Of Interest) in Japanese is entered into ‘oo’]. This “Destination Setting [Facility=?]” means a state where a destination point is wanted to be set but a specific facility name is not yet determined, and “Destination Point Setting [Facility=$Facility$ (=‘oo’ Ramen)]” means a state where a specific facility of “‘oo’ Ramen” is wanted to be set as destination point.

Here, as an intention estimating method by the intention estimation processor 7, a method such as a maximum entropy method, for example, may be utilized. Specifically, such a method may be utilized in which: with respect to a speech of “Want to set a destination point”, from its morphological analysis result, independent words (hereinafter, each referred to as a feature) of “destination point, set” have been extracted and then placed in a set with its correct intention of “Destination Point Setting [Facility=?]”; likewise, a number of sets of features and their intentions have been collected; and from these sets, it is estimated, using a statistical approach, which intention is probable to what extent for input features in the list. In the following, description will be made assuming that the intention estimation is performed utilizing a maximum entropy method.

The intention hierarchical graphic data 8 is data in which intentions are represented in a hierarchical manner. For example, with respect to such two intentions represented by “Destination Point Setting [Facility=?]” and “[Facility=$Facility$ (=‘oo’ Ramen)]”, the more abstract intention of “Destination Point Setting [Facility=?]” is placed at a hierarchically upper level, and “[Facility=$Facility$ (=‘oo’ Ramen)]” in which its specific slot is filled, is placed thereunder. Further, there is held therein information about what is the currently-activated intention having been estimated by the dialog management unit 2.

The intention estimated-weight determination processor 9 is a processing unit that determines, from the intention hierarchical information in the intention hierarchical graphic data 8 and the information about the activated intention, a weight to be given for a score of the intention estimated by the intention estimation processor 7. The transition node determination processor 10 is a processing unit that makes re-evaluation about the list of the intention estimated by the intention estimation processor 7 and the score of that intention, using the weight determined by the intention estimated-weight determination processor 9, to thereby select an intention (including also a case of plural intentions) to be activated next.

The dialog scenario data 11 is data of a dialog scenario in which written is information about what is to be executed from one or plural intentions selected by the transition node determination processor 10. Meanwhile, the dialog history data 12 is data of a dialog history in which a state of each dialog is stored. In the dialog history data 12, there is held information for changing an operation according to a state just before that changing and for returning to a state just before a confirmatory dialog was made, when the user denies confirmation or likewise. The dialog turn generator 13 is a dialog turn generator that inputs one or plural intentions selected by the transition node determination processor 10, and utilizes the dialog scenario data 11 and the dialog history data 12, to thereby generate a scenario for generating a system response, for determining an operation to be executed, for waiting for a next input from the user, or the like. The speech synthesizer 14 is a processing unit that inputs a system response generated by the dialog turn generator 13 to thereby generate a synthesized speech.

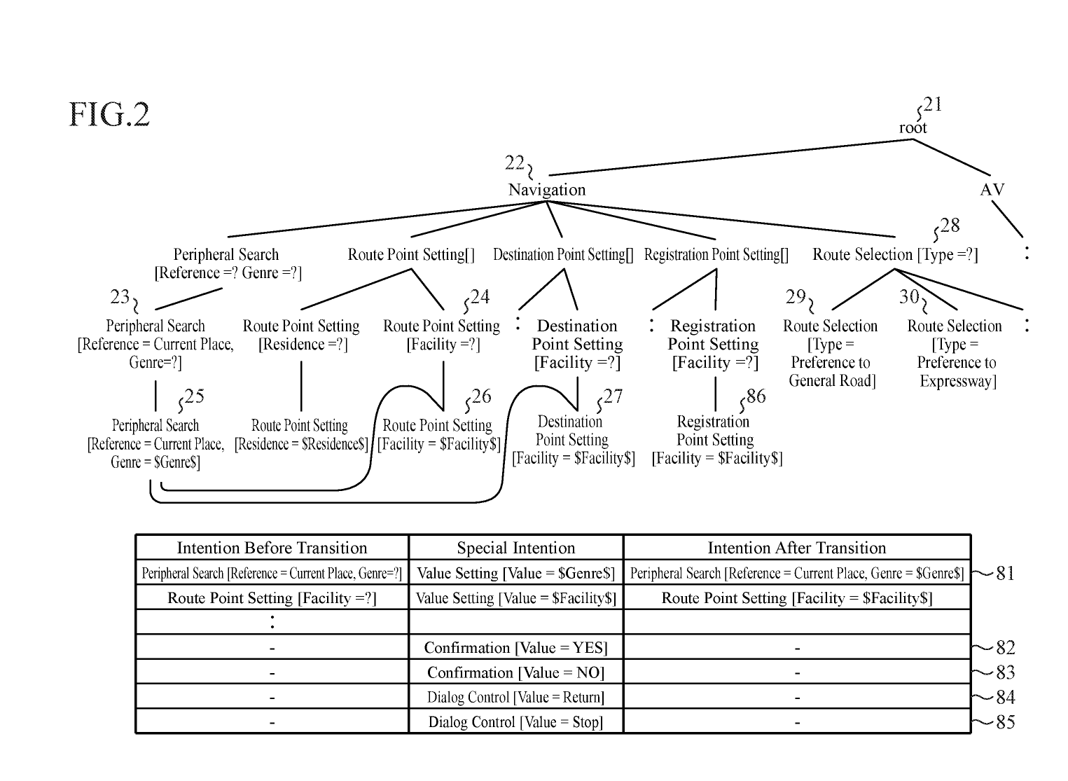

FIG. 2 is an example of intention hierarchical data under assumption of a car-navigation system. In the figure, each of nodes 21 to 30 and 86 is an intention node indicative of an intention in the intention hierarchy. The intention node 21 is a root node uppermost in the intention hierarchy, under which the intention node 22 that represents a mass of navigation functions is hanging down. An intention 81 is an example of a special intention to be set in a transition link. Intentions 82, 83 are each a special intention for a case where it is required for the user to make confirmation during dialog. An intention 84 is a special intention for returning just once in dialog state, and an intention 85 is a special intention for stopping dialog.

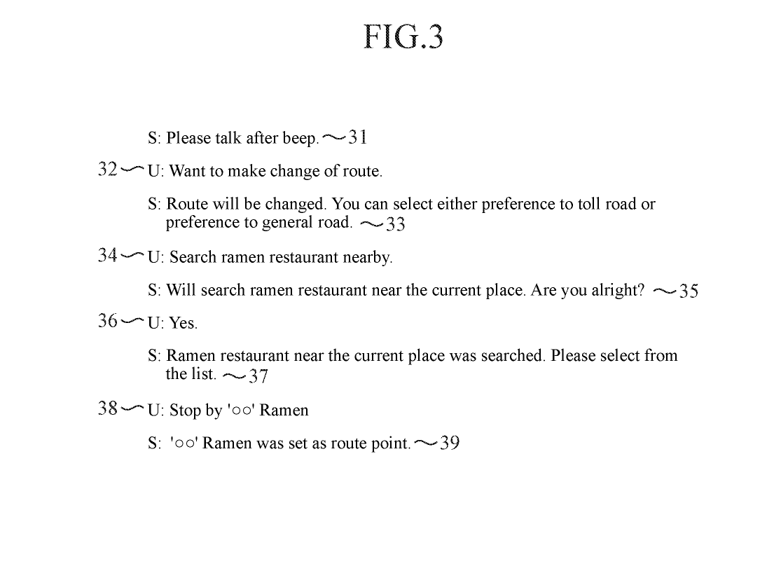

FIG. 3 is a dialog example in Embodiment 1. “U:” at beginning of each line represents a user's utterance. “S:” represents a response from the system. Indicated at 31, 33, 35, 37 and 39 are each system responses, and indicated at 32, 34, 36 and 38 are each user's utterances, and there is thus shown that dialog is proceeding sequentially.

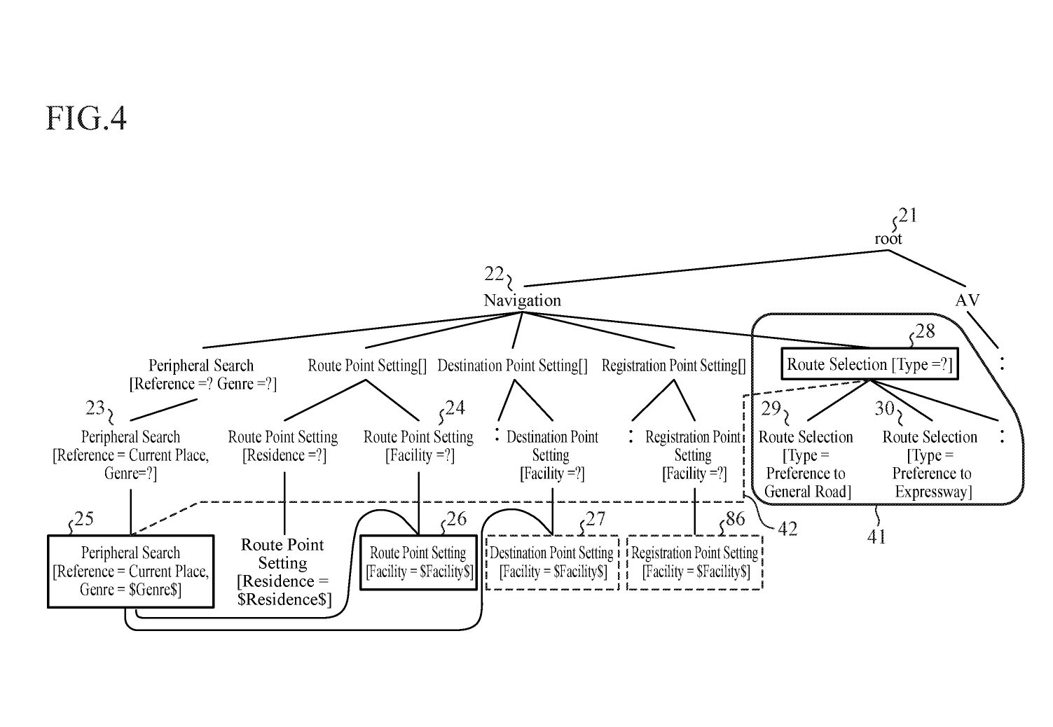

FIG. 4 is a transition example in which what kind of transition of intention node occurs with the progress of the dialog of FIG. 3 is shown. Indicated at 28 is an intention activated by the user's speech 32, at 25 is an intention re-activated by the user's speech 34, at 26 is an intention activated by the user's utterance 38, and at 41 is an intention-preferentially-estimated region in which included is an intention that is preferentially estimated when the intention node 28 is activated. Indicated at 42 is a link after transition.

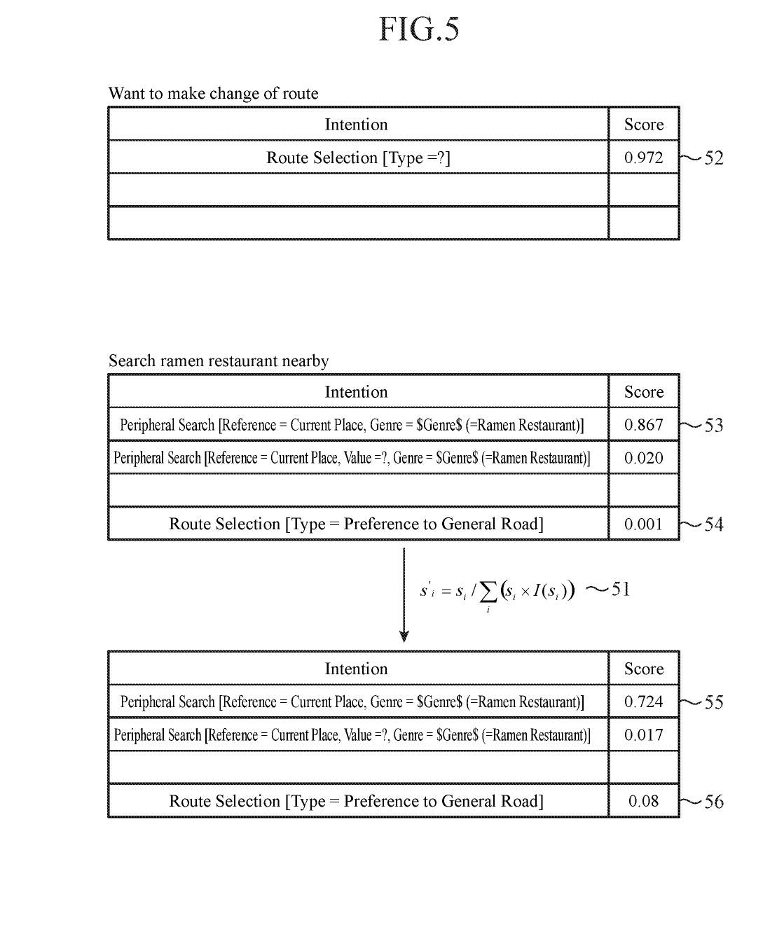

FIG. 5 is an illustration diagram showing an example of intention estimation results, and an example of a formula for correcting the intention estimation results according to a dialog state. A formula 51 represents a score correction formula for the intention estimation results, and indicated at 52 to 56 are the intention estimation results.

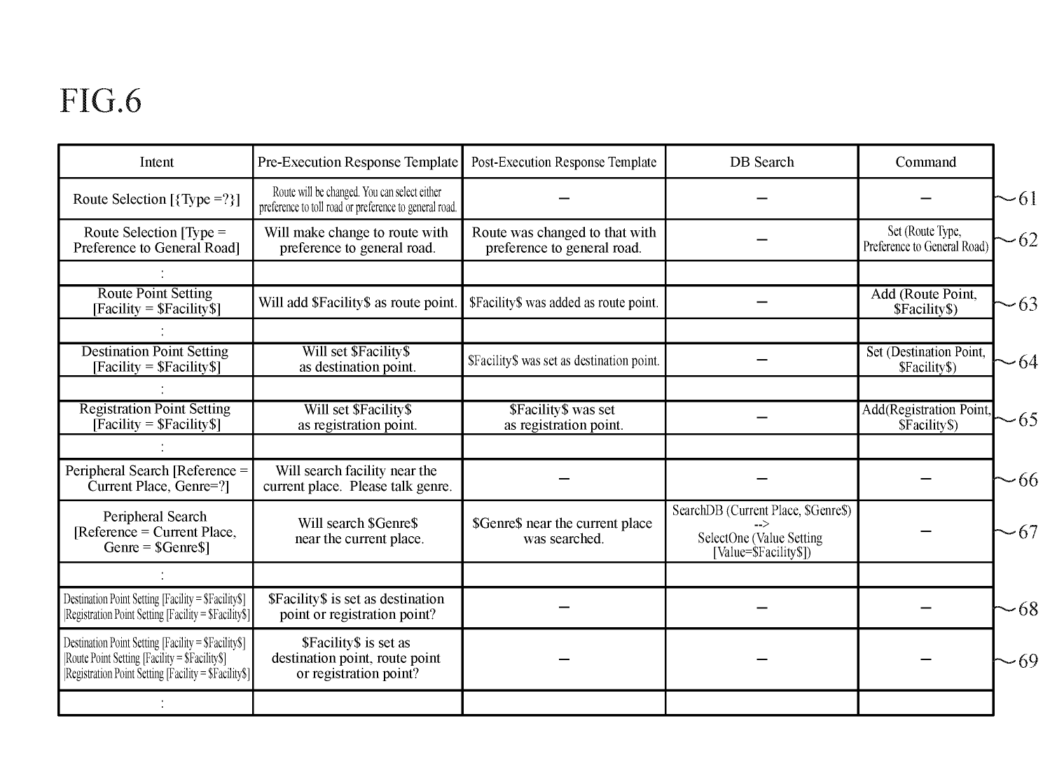

FIG. 6 is a diagram of dialog scenarios stored in the dialog scenario data 11. What kind of system response is to be given to an activated intention node, and what kind of command is to be executed for an apparatus operated by the dialog management system, are written therein. Indicated at 61 to 67 are scenarios for the respective intention nodes. Meanwhile, indicated at 68 and 69 are each scenarios registered for the case where, when plural intention nodes are activated, a system response for making selection therefrom is wanted to be described. In general, when plural intention nodes are activated, a pre-execution response prompt for the dialog scenarios of the respective intention nodes is used so as to make connection to the intention node.

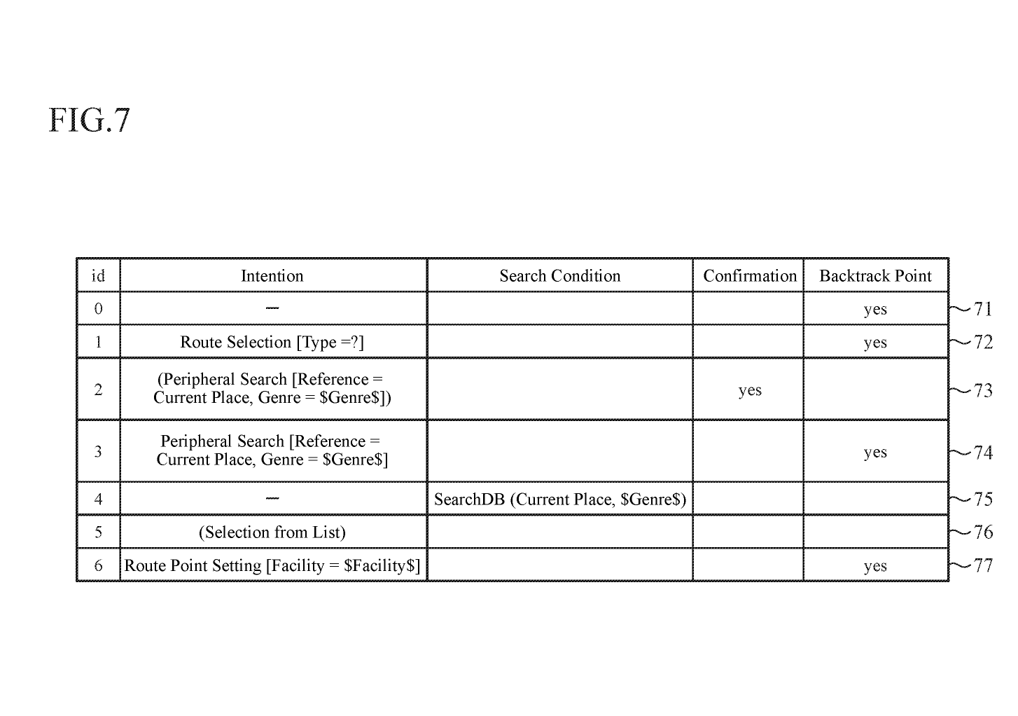

FIG. 7 shows the dialog history data 12, in which indicated at 71 to 77 are backtrack points for the respective intentions.

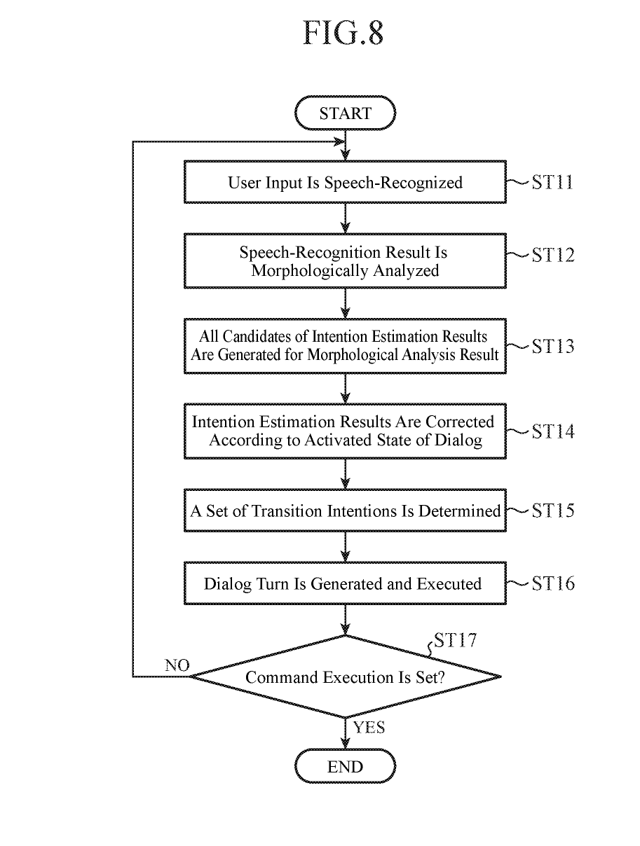

FIG. 8 is a flowchart showing a flow of dialog in Embodiment 1. By following the steps from Step ST11 to Step ST17, dialog is carried out.

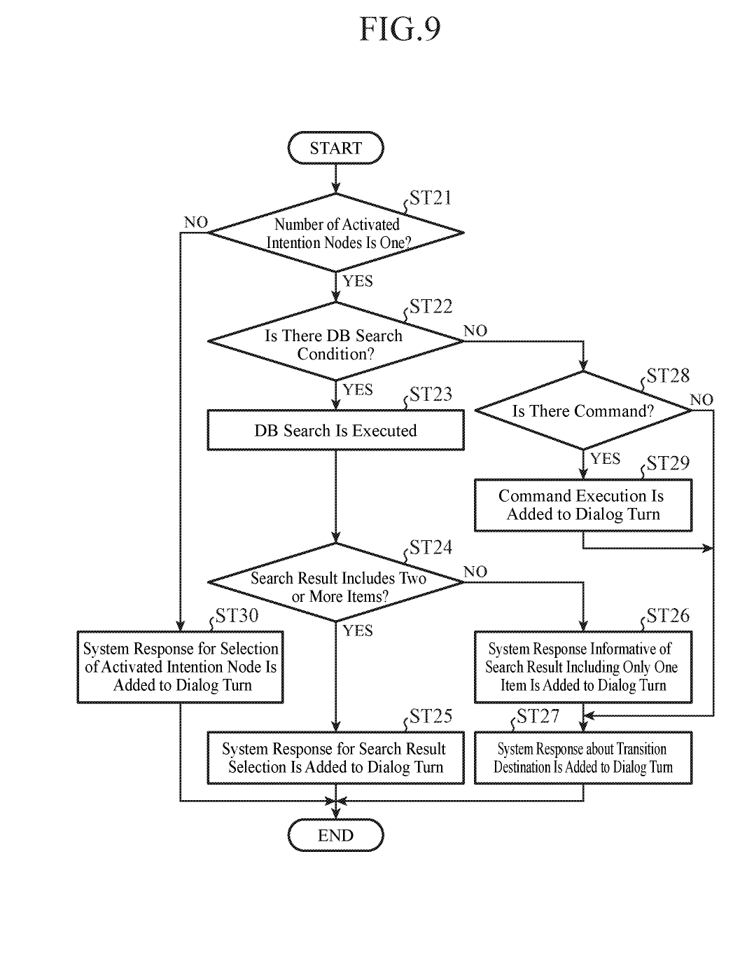

FIG. 9 is a flowchart showing a flow of generation of a dialog turn in Embodiment 1. By following the steps from Step ST21 to Step ST29, a dialog turn when only one intention node is activated is generated. Meanwhile, when plural intention nodes are activated, in Step ST30, a system response for making selection from the activated intention nodes is added to the dialog turn.

Next, operations of the dialog management system of Embodiment 1 will be described. In this embodiment, operations will be described as follows assuming that an input (input by way of one or plural keywords or a sentence) is a speech in a natural language. Further, the invention is irrelevant to a speech-related false recognition, so that, hereinafter, the description will be made assuming that the user's utterance is properly recognized without a false recognition. In Embodiment 1, it is assumed that dialog is started by use of a speech start button that is not explicitly shown here. Further, before dialog is started, every intention node in the intention hierarchical graph in FIG. 2 is placed in a non-activated state.

When the user pushes the utterance start button, dialog is allowed to start, so that the system outputs a system response for promoting starting of dialog and a beep sound. For example, when the utterance start button is pushed, a system response with the system response 31 of “Please talk after beep” is given, and then, with the sounding of a beep, the speech recognizer 4 is placed in a recognizable state. When processing moved to Step ST11, if the user speaks the utterance 32 of “Want to make change of route”, its speech is inputted through the speech input unit 1 and converted into a text by the speech recognizer 4. Here, the speech is assumed to be properly recognized. After completion of the speech recognition, processing moves to Step ST12, so that “Want to make change of route” is transferred to the morphological analyzer 5. The morphological analyzer 5 analyses the recognition result so as to perform morphological analysis in such a manner to provide [“route”/noun, “of”/postpositional particle, “change”/noun (to be connected to the verb “suru” in Japanese), “make”/verb, and “want to”/auxiliary verb in Japanese].

Subsequently, processing moves to Step ST13, so that the result from the morphological analysis is transferred to the intention estimation processor 7 and then intention estimation is performed using the intention estimation model 6. In the intention estimation processor 7, the features to be used for intention estimation are extracted from the morphological analysis result. Firstly, in Step ST13, the features of “Route, Set” are extracted in a form of a list from the morphological analysis result with respect to the recognition result in the case of the utterance 32, and intention estimation is performed based on these features by the intention estimation processor 7. On this occasion, the result of intention estimation is given as the intention estimation result 52, so that there is provided an intention of “Route Selection [Type=?]” with a score of 0.972 (actually, scores are also allocated to the other intentions).

When the intention estimation result is provided, processing moves to Step ST14, so that a set of the intention estimated by the intention estimation processor 7 and its score in a form of a list, is transferred to the transition node determination processor 10 and subjected to correction of the score, and then processing moves to Step ST15, so that a transition node to be activated is determined. For the correction of the score, such a formula with a form of, for example, the score correction formula 51 is used. In the formula, represented by i is an intention, and represented by Sᵢ is a score of the intention i. The function I(Sᵢ) is defined as a function that returns 1.0 when the intention i falls within an intention-preferentially-estimated region that is placed at a hierarchically lower level of an activated intention, and returns α (0≦α≦1) when it is out of the intention-preferentially-estimated region. Note that in Embodiment 1, α=0.01 is given. Namely, if the intention is unable to be transited from an activated intention, its score is lowered to be corrected so that the sum of the scores becomes 1. In a situation just after the speech “Want to make change of route” was made, every node in the intention hierarchical graph is not placed in an activated state. Thus, every score is divided by the sum of all of intention scores having been multiplied by 0.01, so that the score after correction becomes the original score, after all.

Then, in Step ST15, a set of intentions to be activated is determined by the transition node determination processor 10. Examples of an intention-node determination method to be operated by the transition node determination processor 10 include those as follows:

(a) If there is a maximum score of 0.6 or more, only one node with the maximum score is activated;
(b) If there is a maximum score of less than 0.6, plural nodes with a score of 0.1 or more are activated; and
(c) If there is a maximum score of less than 0.1, no activation is made assuming that any intention could not be understood.

In the case of Embodiment 1, in a situation where the utterance of “Want to make change of route” is made, the maximum score becomes 0.972, so that only the intention of “Route Selection [Type=?]” is activated by the transition node determination processor 10.

When the intention node 28 is activated by the transition node determination processor 10, processing moves to Step ST16, so that a processing list for the next turn is generated by the dialog turn generator 13 on the basis of the contents written in the dialog scenario data 11. Specifically, this follows the process flow shown in FIG. 9. Firstly, in Step ST21 in FIG. 9, processing moves to Step ST22 because the intention node 28 is only the activated node. Then, since there is no DB search condition in the dialog scenario 61 for the intention node 28, processing moves to Step ST28. Then, since also no command is defined in the dialog scenario 61, processing moves to Step ST27, so that a system response for selecting the lower level intention node 29, 30 or the like under the intention node 28 is generated. For that response, the intention scenario 61 is selected, and a pre-execution prompt of “Route will be changed. You can select either preference to toll road or preference to general road” is added, as a system response, to the dialog turn, and then the flow in FIG. 9 terminates. In Step ST16, the dialog management unit 2 receives the dialog turn, and processes sequentially each piece of the processing added to the dialog turn. A speech of the system response 33 is generated by the speech synthesizer 14, and outputted from the speech output unit 3. After completion of execution of the dialog turn, processing moves to Step ST17. Then, since there is no command in the dialog turn, processing moves to Step ST11, to provide a user-input waiting state.

One dialog turn is completed at the time the speech-input waiting state is provided, and then, processing is continued by the dialog management unit 2. Thereafter, the flow in FIG. 8 is repeated, and thus its detailed description is omitted. Here, let's assume that the user's speech 34 of “Search ramen restaurant nearby” is inputted, properly recognized by the speech recognizer 4 and morphologically analyzed by the morphological analyzer 5, and the result from intention estimation by the intention estimation processor 7 based on the morphological analysis result, is obtained as shown by the intention estimation results 53 and 54. Then, since only the intention node 28 is being activated at this time, the transition node determination processor 10 recalculates each score according to the score correction formula 51 while keeping without change the score of the intention estimation result 54 from the intention-preferentially-estimated region 41, and multiplying by a the score of the intention estimation result 53 from out of the intention-preferentially-estimated region. The result of the recalculation is as shown by the intention estimation results 55 and 56, so that the intention estimation result 55 is determined, even if a weight is given thereto, to be the intention of the user's utterance and the intention node 25 is provided as an activated node.

In light of the fact that there is an activated intention node having been transited but no link from the transition source, the dialog turn generator 13 generates a dialog turn. Because of shifting to a node with no transition link, the generation is executed in a confirmed way. Firstly, when the dialog scenario is selected, a pre-execution prompt of “Will search $Genre$ near the current place” is selected, and then, from the information “$Genre$ (=Ramen restaurant)” of the intention estimation result, “$Genre$” is replaced with “Ramen restaurant”, so that there is generated “Will search ramen restaurant near the current place”. Further, a confirmatory response is added, so that “Will search ramen restaurant near the current place. Are you alright?” is determined as the system response. Then, since no command is defined, with assumption that dialog continues, there is provided a user-input waiting state.

Here, if the user makes a speech as shown by the user's speech 36 of “Yes”, a confirmatory special intention of “Confirmation [Value=YES]” is generated by the speech recognizer 4, the morphological analyzer 5 and the intention estimation processor 7. For the process by the transition node determination processor 10, the effective special intention 82 of “Confirmation [Value=YES]” is selected, so that the transition to the intention node 25 is ascertained (shown by the transition link 42). Note that, if the user makes an unfavorable speech, such as “No”, a special intention of “Confirmation [Value=NO]” is estimated as an intention estimation result with a high score by the intention estimation processor 7. Since the special intention 83 of “Confirmation [Value=NO]” is effective for the process by the transition node determination processor 10, based on the dialog history data 12 shown in FIG. 7, the flow returns to the backtrack point just before, so that dialog for promoting a new input is continued.

Then, after the state of the intention node 25 is ascertained, at the dialog turn generator 13 and using the dialog scenario 67, “$Genre$” in a post-execution prompt of “$Genre$ near the current place was searched” is replaced with “Ramen restaurant” to thereby generate a system dialog response of “Ramen restaurant near the current place was searched”. Then, since there is a DB search condition in the dialog scenario 67, the DB search of “SearchDB (Current place, Ramen restaurant)” is added to the dialog scenario so as to be executed, and upon receiving the execution result, “Please select from the list” is added as a system response to the dialog turn, and then processing moves to the next one (in FIG. 9, Step ST22→Step ST23→Step ST24→Step ST25). Note that, if the search result of the DB search includes only one item, processing moves to Step ST26 to thereby add to the dialog turn, a system response informative of the fact that the search result includes only one item, and then processing moves to Step ST27.

The dialog management unit 2 outputs by speech the system response 37 of “Ramen restaurant near the current place was searched. Please select from the list” according to the received dialog turn, and displays the list of DB-searched ramen restaurants, and is then placed in a user's speech waiting state. When the user's utterance 38 of “Stop by ‘oo’ Ramen” is uttered by the user and it is properly speech-recognized, morphologically analyzed and understood in intention, an intention of “Route-point Setting [Facility=$Facility$]” is intention-estimated. Since this intention of “Route-point Setting [Facility $Facility$]” is at a level lower than the intention node 25, so that a transition to the intention node 26 is executed.

As the result, the dialog scenario 63 for the intention node 26 of “Route-point Setting [Facility=$Facility$]” is selected, and a command of “Add (Route point, ‘oo’ Ramen)” is added to the dialog turn. Subsequently, the system response 39 of “‘oo’ Ramen was set to the route point” is added to the dialog turn (in FIG. 9, Step ST22→Step ST28→Step ST29→Step ST27).

Lastly, the dialog management unit 2 executes the received dialog turn, sequentially. Namely, it executes adding of the route point and further, outputting of “‘oo’ Ramen was set as route point” using a synthesized speech. In the dialog turn, a command execution is included, so that after the termination of the dialog, the management unit returns to the initial utterance-start waiting state.

As described above, according to the dialog management system of Embodiment 1, it comprises: an intention estimation processor that, based on data provided by converting an input in a natural language into a morpheme string, estimates an intention of the input; an intention estimated-weight determination processor that, based on data in which intentions are arranged in a hierarchical structure and based on the intention thereamong being activated at a given object time, determines an intention estimated weight of the intention estimated by the intention estimation processor; a transition node determination processor that determines an intention to be newly activated through transition, after correcting an estimation result by the intention estimation processor according to the intention estimated weight determined by the intention estimated-weight determination processor; a dialog turn generator that generates a turn of dialog from one or plural intentions activated by the transition node determination processor; and a dialog management unit that, when a new input in the natural language is provided due to the turn of dialog generated by the dialog turn generator, controls at least one process among processes performed by the intention estimation processor, the intention estimated-weight determination processor, the transition node determination processor and the dialog turn generator, followed by repeating that controlling, to thereby finally execute a setup command. Thus, even for an unexpected input, an appropriate transition is performed and thus processing matched to the user's request can be carried out.

Further, according to the dialog management method of Embodiment 1, it uses a dialog management system that estimates an intention of an input in a natural language to perform dialog and, as a result, to execute a setup command, and comprises: an intention estimation step of estimating the intention of the input, based on data provided by converting the input in the natural language into a morpheme string; an intention estimated-weight determination step of determining, based on data in which intentions are arranged in a hierarchical structure and based on the intention thereamong being activated at a given object time, an intention estimated weight of the intention estimated in the intention estimation step; a transition node determination step of determining an intention to be newly activated through transition, after correcting an estimation result in the intention estimation step according to the intention estimated weight determined in the intention estimated-weight determination step; a dialog turn generation step of generating a turn of dialog from one or plural intentions activated in the transition node determination step; and a dialog control step of controlling, when a new input in the natural language is provided due to the turn of dialog generated in the dialog turn generation step, at least one step among the intention estimation step, the intention estimated-weight determination step, the transition node determination step and the dialog turn generation step, followed by repeating that controlling, to thereby finally execute a setup command. Thus, even for an unexpected input, an appropriate transition is performed and thus processing matched to the user's request can be carried out.

### Embodiment 2

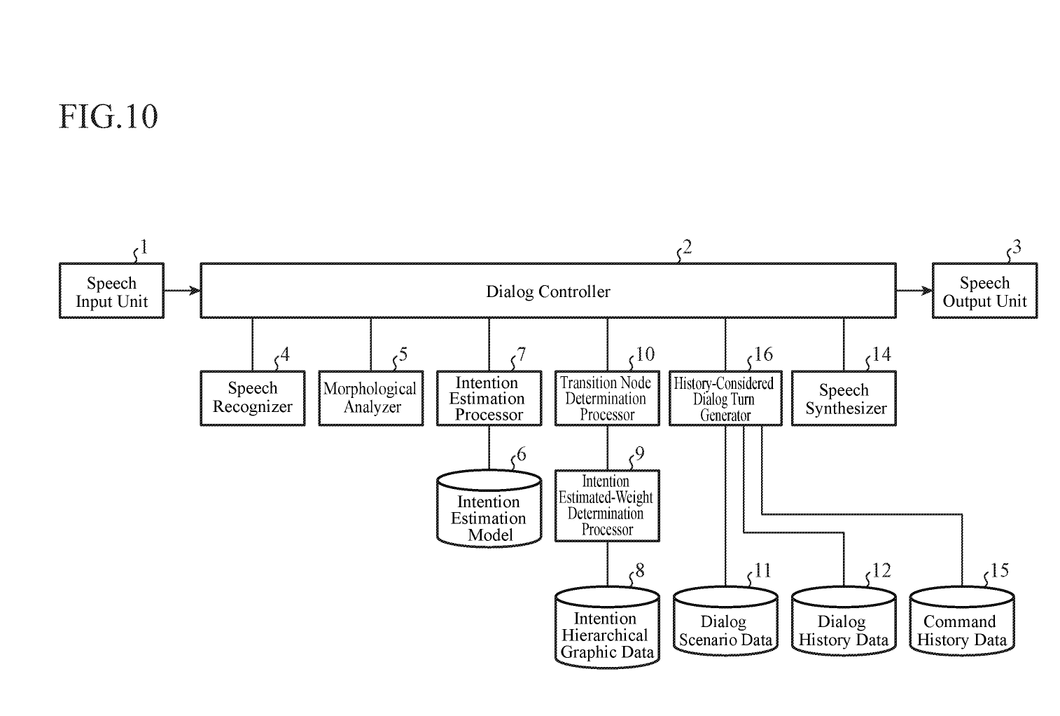

FIG. 10 is a configuration diagram showing a dialog management system according to Embodiment 2. In the figure, a speech input unit 1 to a dialog history data 12 and a speech synthesizer 14 are the same as those in Embodiment 1, so that the same reference numerals are given to the corresponding parts and description thereof is omitted here.

A command history data 15 is data in which each command having been executed so far is stored with its execution time. Further, a history considered dialog turn generator 16 is a processing unit that generates a dialog turn by use of the command history data 15, in addition to having the functions of the dialog turn generator 13 in Embodiment 1 that uses the dialog scenario data 11 and the dialog history data 12.

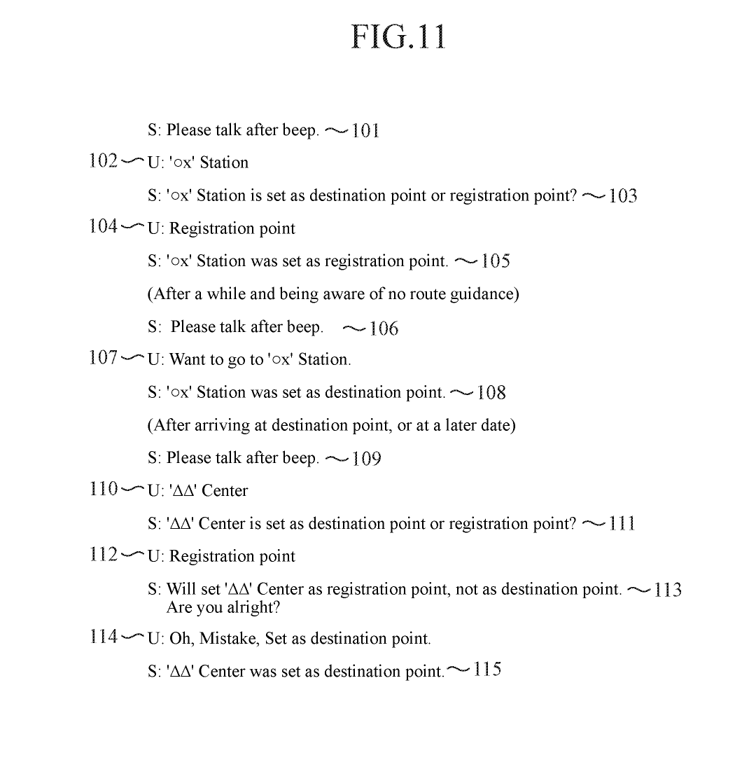

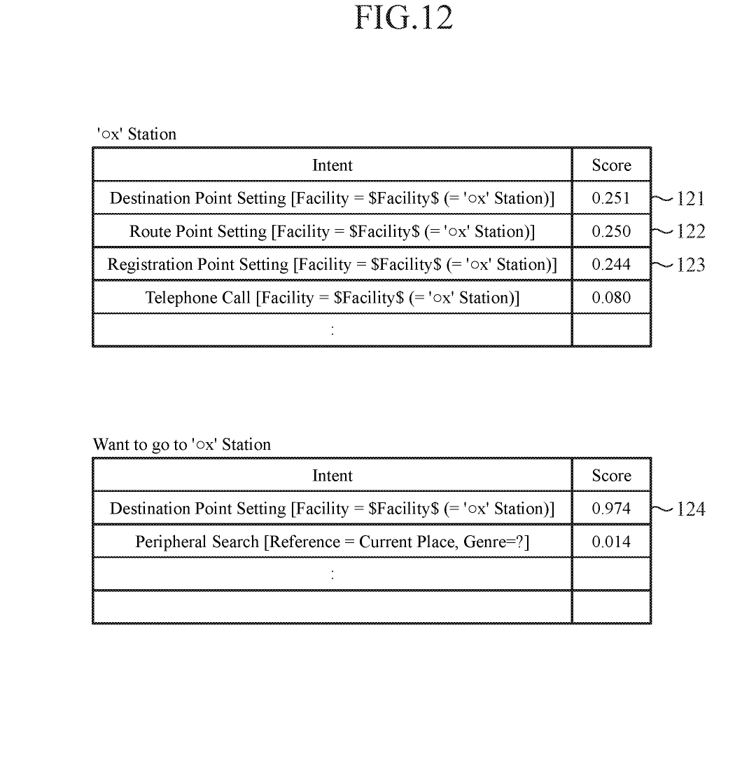

FIG. 11 is a dialog example in Embodiment 2. Similarly to FIG. 3 in Embodiment 1, indicated at 101, 103, 105, 106, 108, 109, 111, 113 and 115 are each system responses, and indicated at 102, 104, 107, 110, 112 and 114 are each user's speeches, and there is thus shown that dialog is proceeding sequentially. FIG. 12 is a diagram showing an example of intention estimation results. Indicated at 121 to 124 are each intention estimation results.

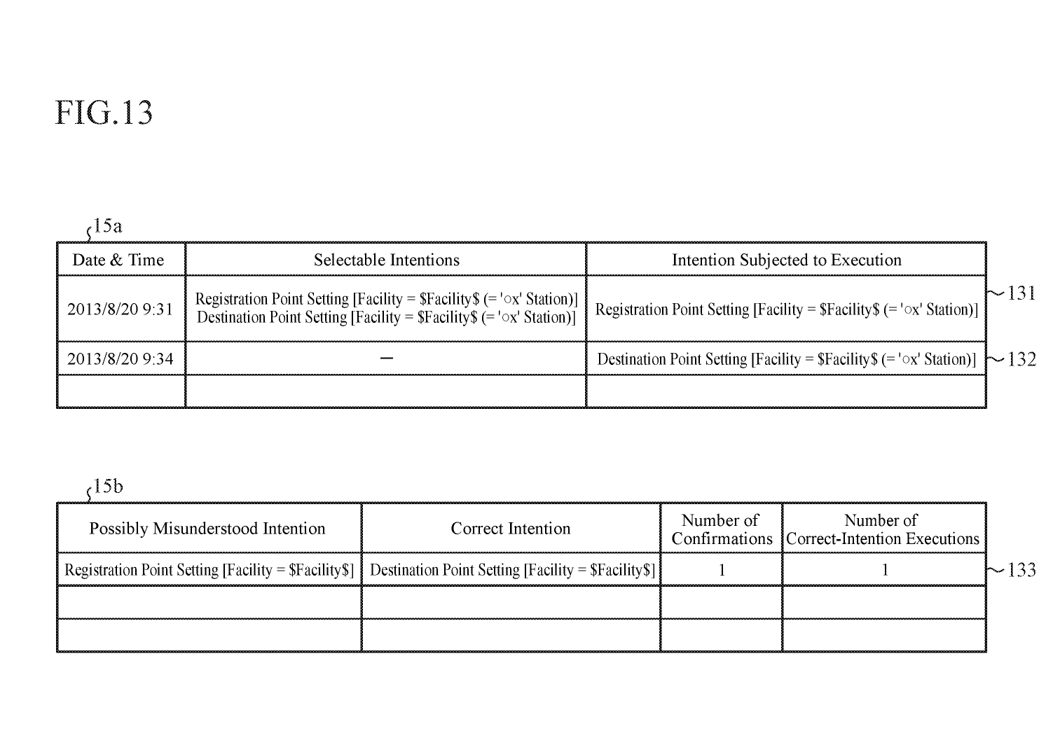

FIG. 13 is an example of the command history data 15. The command history data 15 is composed of a command execution history list 15a and a possibly misunderstood command list 15b. In each command execution history in the command execution history list 15a, a result from execution of a command is being recorded with time. Meanwhile, the possibly misunderstood command list 15b is a list in which selectable intentions in the command execution history are registered when, among the intentions, the intention other than the intention having been subjected to execution is thereafter subjected to execution within a specified time period.

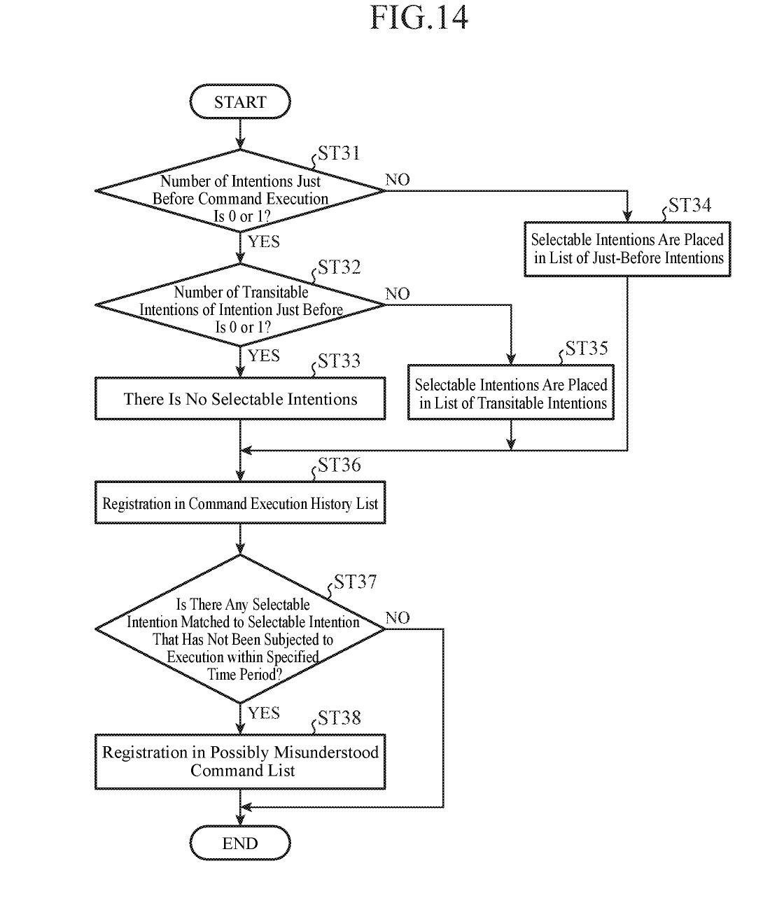

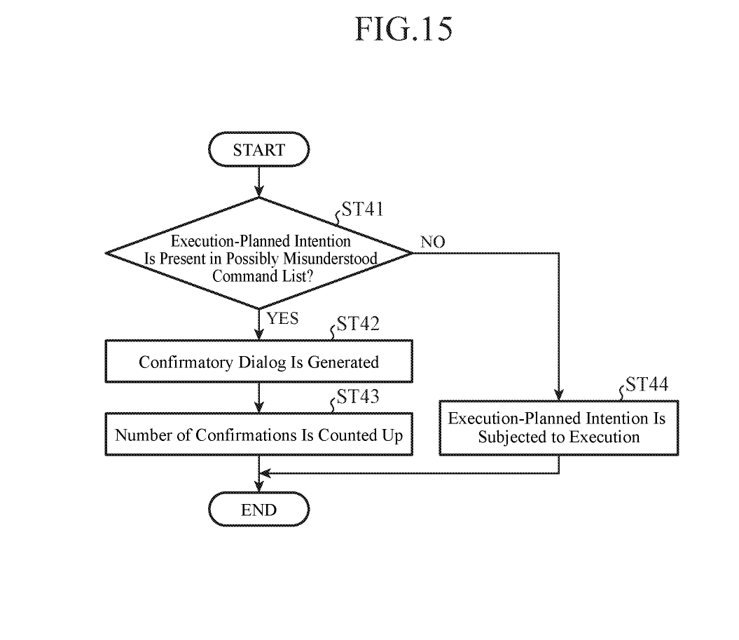

FIG. 14 is a flowchart in a data addition process to the command history data 15 when a turn is generated by the history-considered dialog turn generator 16, according to Embodiment 2. Further, FIG. 15 is a flowchart showing a process about whether or not to make confirmation to the user when a command execution-planned intention is determined by the history-considered dialog turn generator 16.

Next, operations of the dialog management system of Embodiment 2 will be described. Although the operations in Embodiment 2 are basically the same as those in Embodiment 1, there is a difference from Embodiment 1 in that the operation of the dialog turn generator 13 is replaced with the operation of the history-considered dialog turn generator 16 that operates additionally with the command history data 15. Namely, the difference from Embodiment 1 resides in that when, with respect to a system response, a possibly-misunderstood intention is finally selected as an intention with a command definition, a scenario to be carried out is not directly generated, but a dialog turn for making confirmation is generated.

The dialog in Embodiment 2 shows a case where the user not well-understanding the application has added a registration point with his/her intention of setting a destination point, and thereafter, becomes aware of that fact and sets again the place as the destination point. The entire flow of the dialog is similar to in Embodiment 1 and thus follows the flow in FIG. 8, so that the operation similar to in Embodiment 1 is omitted from description. Further, with respect also to the generation of a dialog turn, it similarly follows the flow in FIG. 9.

In the following, description will be made according to the contents of the dialog in FIG. 11. When the user pushes the speech start button, dialog is allowed to start, and the system response 101 of “Please talk after beep” is outputted by speech. Here, let's assume that the user's speech 102 of “‘ox’ Station” is spoken [a specific POI (Point Of Interest) in Japanese is entered into ‘ox’]. When the user's utterance 102 was uttered, the intention estimation results 121, 122 and 123 are obtained through the speech recognizer 4, the morphological analyzer 5 and the intention estimation processor 7. In this state, there is no activated intention node, so that the scores after correction of the intention estimation results by the transition node determination processor 10 become equal to the scores of the intention estimation results 121, 122, 123, without change. The transition node determination processor 10 determines an intention node to be activated, based on the intention estimation results. Here, if an intention node to be activated is determined under the same conditions as in Embodiment 1, this corresponds to the method (b), so that the intention nodes 26, 27 and 86 are activated. However, if there is an intention node that cannot be selected depending on a state of the application, it is not activated. For example, when a destination point is not set, it is unable to set its route point, so that the intention node 26 is not activated. Here, such a state is assumed that the intention node 26 is not activated because no destination point is set.

Because what is activated are the intention nodes 27 and 86, the dialog scenario 68 is selected, and “‘ox’ Station is set as destination point or registration point?” is added as a system response to the scenario (in FIG. 9, Step ST21→Step ST30). The lastly made-up scenario is transferred to the dialog management unit 2, so that the system response 103 is outputted, and then the management unit is placed in a user's speech waiting state. Here, when the user's speech 104 of “registration point” is spoken, it is subjected to speech recognition and intention estimation like the above, and then the intention node 86 is selected as an intention estimation result, the dialog scenario 65 is selected so that the command of “Add (Registration point, ‘ox’ Station)” is registered in the dialog turn, and a system response of “‘ox’ Station was added as registration point” is added to the dialog turn (in FIG. 9, Step ST21→Step ST22→Step ST28→Step ST29→Step ST27). Then, the history-considered dialog turn generator 16 determines whether or not to make registration in the command execution history, according to the flow in FIG. 14.

Firstly, in Step ST31, it is determined whether the number of intentions just before command execution is 0 or 1. Here, the intentions just before command execution are two intentions of [Registration Point Setting [Facility=$Facility$ (=‘ox’ Station)]” and [Destination Point Setting [Facility $Facility$ (=‘ox’ Station)]”, so that the flow moves to Step ST34. In Step ST34, [Registration Point Setting [Facility=$Facility$ (=‘ox’ Station)]” and [Destination Point Setting [Facility=$Facility$ (=‘ox’ Station)]” are determined as selectable intentions. Then, in Step ST36, a command execution history 131 is added to the command execution history list. Furthermore, in Step ST37, the selectable intentions are to be registered in the possibly misunderstood command list 15b when, among them, the intention other than the intention having been subjected to execution is thereafter subjected to execution within a specified time period; however, at the time the command execution history 131 is registered, a command execution history 132 is not present, so that the flow terminates with nothing to do.

Then, after a while, because the route guidance toward the “‘ox’ Station”, that the user believes to have set, is not initiated, the user becomes aware that what he/she has wanted to do is not going well. Thus, dialog is newly started. Here, if the user utters “Want to go to ‘ox’ Station” as indicated by the user's utterance 106, the intention estimation result 124 is obtained, resulting in setting of the destination point. Then, processing moves to Step St31, and because of no intention just before, further moves to Step ST32. Because of Step ST32 and absence of the intention itself just before, processing moves to Step ST33, and further to Step ST36, so that the command execution history 132 is registered.

After the command execution history is registered, in Step ST37, if, among the selectable intentions with ambiguities, the intention other than the intention having been selected is thereafter selected within a specified time period (for example, 10 minutes), processing moves to Step ST38, so that, assuming that it is possibly due to the user's misunderstanding, the intentions are registered in the possibly misunderstood command list 15b. Judging from the command execution histories 131, 132, there is a possibility that a destination point setting is misunderstood as a registration point setting, so that a command misunderstanding possibility 133 is added and the number of confirmations and the number of correct-intention executions are provided as 1 each.

Let's assume that, at a later date, the user makes the same misunderstanding when going to set a destination point. When, for example, the user speaks the user's utterance 110 of “‘ΔΔ’ Center” [a specific POI (Point Of Interest) in Japanese is entered into ‘ΔΔ’], its intention is understood similarly like the initial speech, so that the system response 111 of “‘ΔΔ’ Center is set as destination point or registration point?” is generated, to thereby wait for a user's utterance. If the user makes an utterance erroneously like before as the user's utterance 112 of “Registration point”, the intention estimation result becomes “[Registration Point Setting [Facility $Facility$ (=‘ΔΔ’ Center)]”. Thus, in the history-considered dialog turn generator 16, processing moves to Step ST41, and then, because the data of “Registration Point Setting [Facility=$Facility$]” is present in the possibly misunderstood command list 15b, processing moves to Step ST42. In Step ST42, the system response 113 for promoting confirmation of “Will set ‘ΔΔ’ Center as registration point, not as destination point. Are you alright?” is generated. Then, processing moves to Step ST43 and, after adding 1 to the number of confirmations, processing terminates. Meanwhile, in Step ST41, if the execution-planned intention is not present in the possibly misunderstood command list 15b, processing moves to Step ST44, so that the execution-planned intention is subjected to execution.

After outputting the system response 113, the dialog management unit 2 waits for a user's utterance, and when the user's response 114 of “Oh, Mistake, Set as destination point” is made, “Destination Point Setting [Facility=$Facility$ (=‘ΔΔ’ Center)]” is selected and is subjected to execution.

Thereafter, as the user understands the difference between “Registration point” and “Destination point”, a destination point will be set without use of the languages “Registration point”, so that the number of correct-intention executions is increased without increasing the number of confirmations. Namely, there will be no case where, among the possibly misunderstood intentions being present in the possibly misunderstood command list 15b, an intention that has not been subjected to execution is subjected to execution within a specified time period.

By deleting the data in the possibly misunderstood command list to quit confirmation at the time the number of correct-intention executions/the number of confirmations exceeds, for example, 2, it is possible to promote dialog smoothly.

As described above, according to the dialog management system of Embodiment 2, it comprises: instead of the dialog turn generator, a history-considered dialog turn generator that generates a turn of dialog from one or plural intentions activated by the transition node determination processor, and that records each command having been executed as a result by the dialog, to thereby generate a turn of dialog using a list in which selectable intentions in a history of executed commands are registered when among the intentions, the intention other than the intention having been subjected to execution is thereafter subjected to execution within a specified time period. Thus, even if there is a possibility of misunderstanding on a command by the user, an appropriate transition can be performed, to thereby execute an appropriate command.

Further, according to the dialog management system of Embodiment 2, when, among the selectable intentions in the history of executed commands, the intention other than the intention having been subjected to execution is thereafter subjected to execution within a specified time period, the history-considered dialog turn generator generates a turn of dialog for making confirmation; and, after generation of said turn of dialog, when, among the selectable intentions being present in the list, the intention other than the intention having been subjected to execution is not subjected to execution within a predetermined time period, and this condition is repeated a setup number of times, the history-considered dialog turn generator deletes the list and stops generation of said turn of dialog for making confirmation. Thus, when the user does not understand a proper command, it is possible to take an appropriate measure for dealing therewith. Meanwhile, when the user has understood a proper command, it is possible to prevent from making useless confirmation, or likewise.

### Embodiment 3

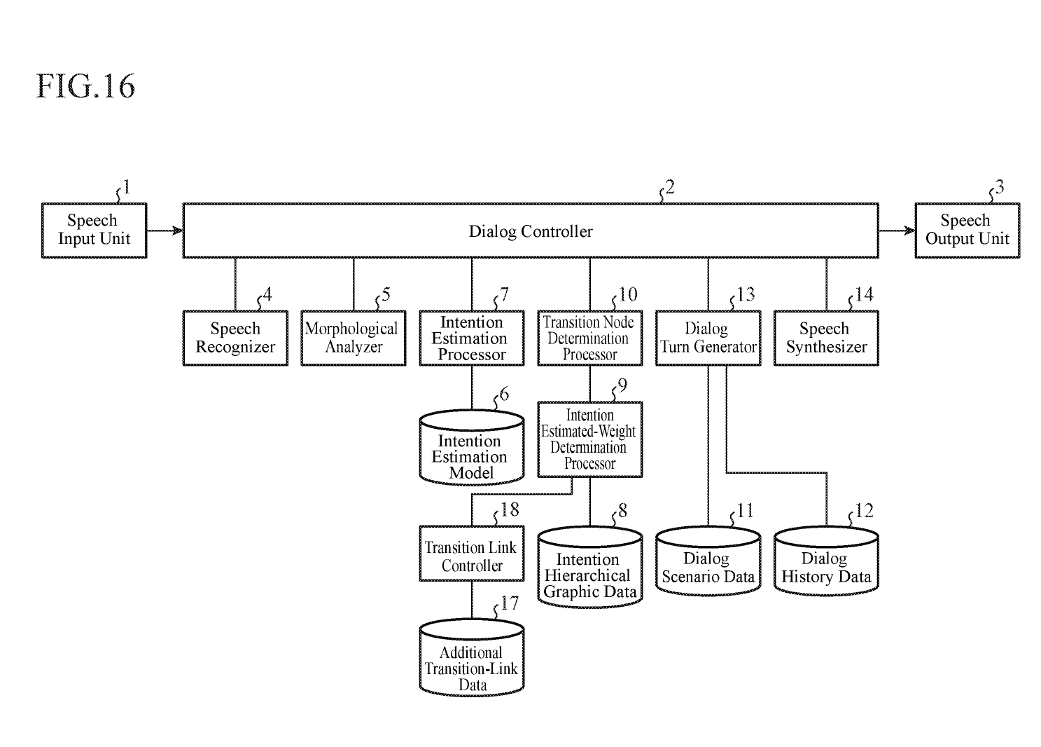

FIG. 16 is a configuration diagram showing a dialog management system according to Embodiment 3. The illustrated dialog management system includes an additional transition-link data 17 and a transition link controller 18, in addition to a speech input unit 1 to a speech synthesizer 14. Configurations of the speech input unit 1 to the speech synthesizer 14 are the same as those in Embodiment 1, so that description thereof is omitted here. The additional transition-link data 17 is data in which a transition link when an unexpected transition is executed is recorded. Further, the transition link controller 18 is a control unit that performs adding data to the additional transition-link data 17 and modifying the intention hierarchical data on the basis of the additional transition-link data 17.

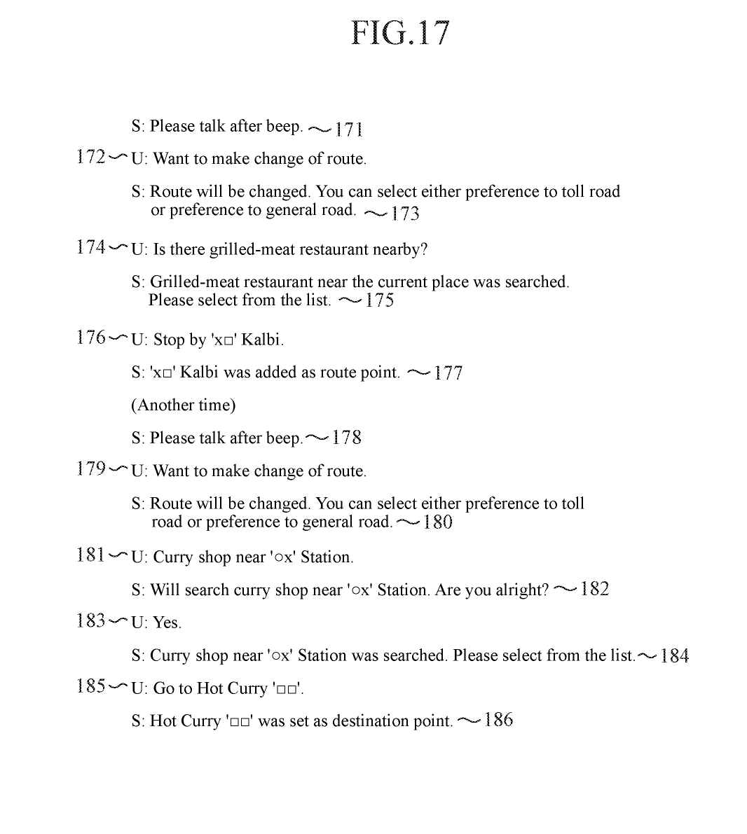

FIG. 17 is a dialog example in Embodiment 3. The dialog of FIG. 17 is an example of dialog that was executed at another time after the dialog of FIG. 3 had been made and a command had been executed. Similarly to FIG. 3, indicated at 171, 173, 175, 177, 178, 180, 182, 184 and 186 are each system responses, and indicated at 172, 174, 176, 179, 181, 183 and 185 are each user's speeches, and there is thus shown that dialog is proceeding sequentially.

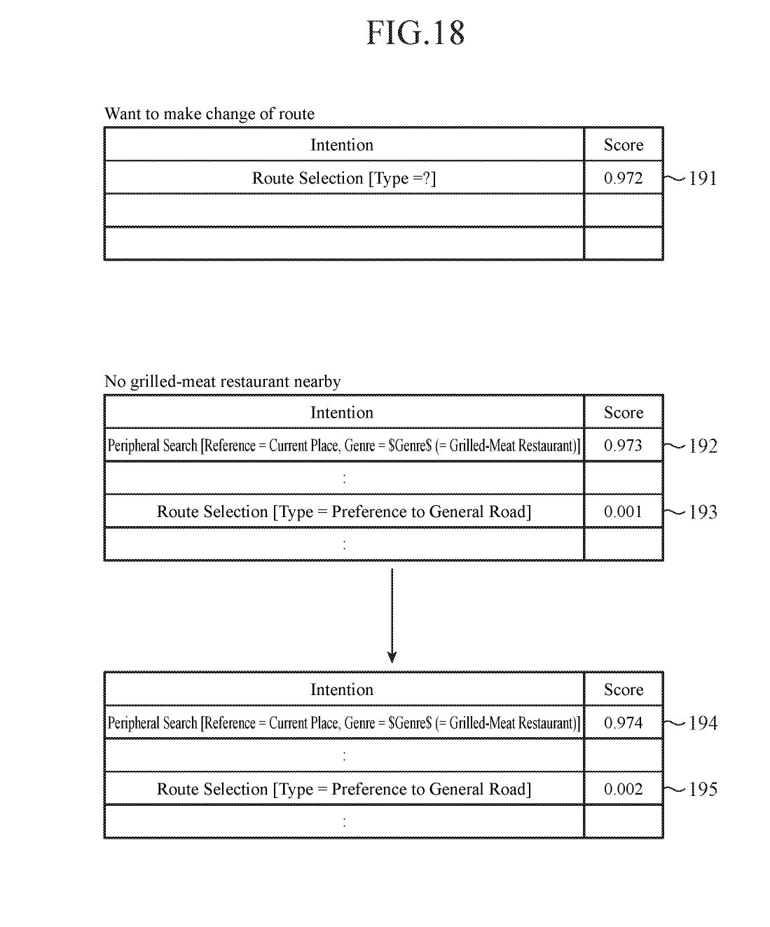

FIG. 18 is an example of intention estimation results according to Embodiment 3. Indicated at 191 to 195 are each intention estimation results.

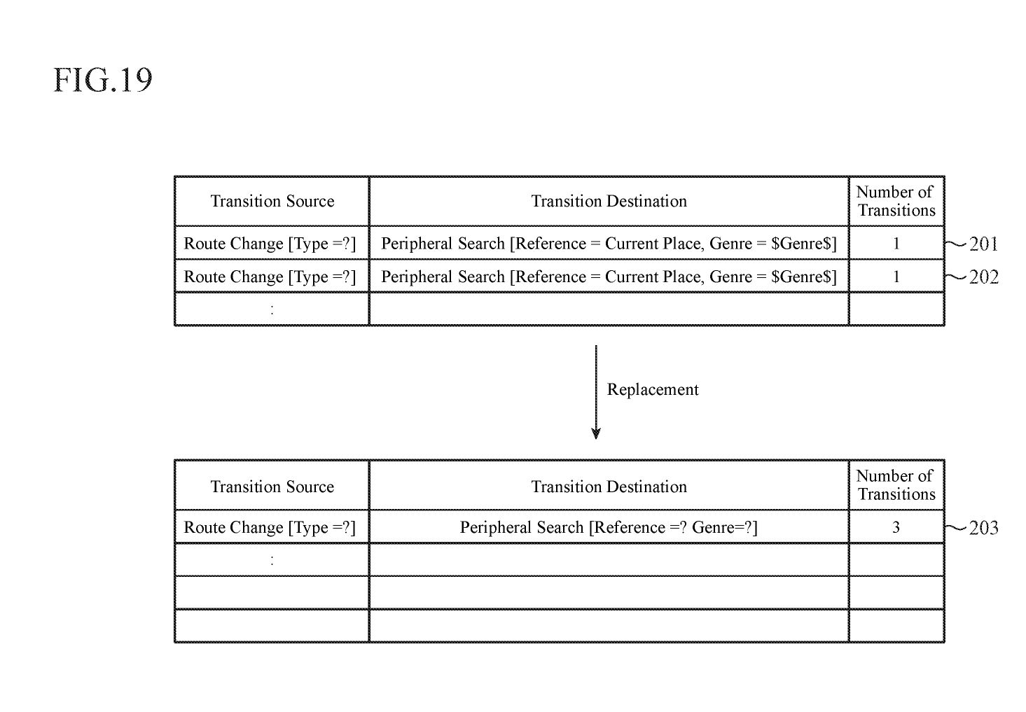

FIG. 19 is an example of the additional transition-link data 17. Indicated at 201, 202, 203 are each additional transition links.

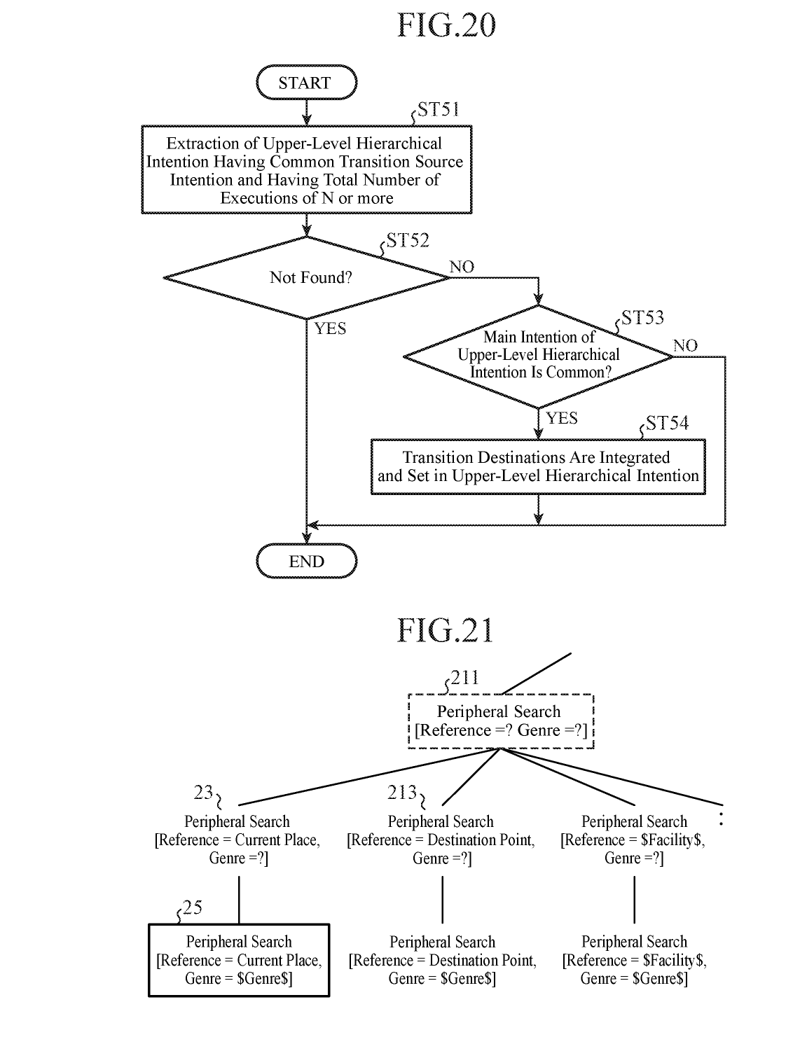

FIG. 20 is a flowchart showing a process when transition-link integration processing is performed by the transition link controller 18.

FIG. 21 is an example of the intention hierarchical data after integration.

Next, operations of the dialog management system of Embodiment 3 will be described.

The initial dialog in Embodiment 3 includes the dialog contents in FIG. 3, so that “Route Point Setting [Facility=$Facility$]” is determined according to the system response 39 followed by execution of the command. During that dialog so far, a transition by the link 42 in FIG. 4 is selected. Here, at the time a transition destination is determined by the transition node determination processor 10, the intention estimation result 191 is added as data of an additional transition link to the additional transition-link data 17, through the intention estimated-weight determination processor 9 and the transition link controller 18.

Let's assume that the dialog in FIG. 17 continues, subsequently. Dialog is allowed to start by the system response 171, and then the use's speech 172 of “Want to change the route” is spoken by the user like in the dialog in FIG. 3. As the result, the intention estimation processor 7 generates the intention estimation result 52 in FIG. 5, so that the intention node 28 is selected and the system response 173 is outputted like in the dialog in FIG. 3, to thereby wait for a user's speech. Here, when the user's speech 174 of “Is there grilled-meat restaurant nearby?” is spoken by the user, the intention estimation results 192, 193 are obtained.

Here, since there is the additional transition link 201, calculation on transition intention is made with assumption of the presence of the transition link 42, so that the intention estimation results 194, 195 are obtained. The transition node determination processor 10 activates only the intention node 25 as a transition node. The dialog turn generator 13, since it prosecutes processing with assumption of the presence of the transition link 42, adds the system response 175 to the scenario without making confirmation to the user, and then, shifts processing to the dialog management unit 2. The dialog management unit 2 promotes dialog thereby to output the system response 175 and then, based on the user's speech 176, to make transition to the intention node 26 with “Route Point Setting [Facility=$Facility$ (=‘x□’ Kalbi)]” [a specific POI (Point Of Interest) in Japanese is entered into ‘x□’]. As the result, the dialog scenario 63 is selected and, because of the presence of a command therefor, the command is executed, so that processing terminates; however, because of the presence of the transition link 42 in transition of the dialog, 1 is added to the number of transitions of the additional transition link 201.

When the number of transitions of the additional transition link 201 is updated, according to the flow in FIG. 20, it is determined whether or not it is possible to re-establish a link to an upper-level intention in the intention hierarchy, and if re-establishing is possible, re-establishing will be performed. In Step ST51, because the number of transitions of the additional transition link 201 has been incremented by 1, another transition destination whose transition source is in common with that of the additional transition link 201 is going to be extracted. Here, because of still being in a state without the additional transition link 202, there is only the additional transition link 201. Accordingly, N=2 is given. Here, if the condition of N in Step ST51 is given as 3, there is no corresponding upper-level hierarchical intention in Step ST52 to provide “YES”, so that processing terminates.

Let's further assume that, in another time, the other subsequent dialog in FIG. 17 proceeds. When the user's speech 181 is spoken, this provides the intention estimation result of “Peripheral Search [Reference=$POI$, Genre=$Genre$]”. At this time, this intention is not registered as data of the additional transition link in the additional transition-link data 17, so that, like in the dialog contents in FIG. 3, the system response 182 is outputted to thereby make confirmation. Finally, the intention of destination point setting is selected according to the user's speech 185 and its command is executed, so that the destination point becomes “Hot Curry ‘□□’” [a specific POI (Point Of Interest) in Japanese is entered into ‘□□’]. At this time, the additional transition link 202 is added.

When the data of the additional transition link is added, according to the flow in FIG. 20, it is determined whether or not it is possible to re-establish a link to an upper-level intention in the intention hierarchy, and if re-establishing is possible, re-establishing will be performed. In Step ST51, the number of transitions of the additional transition link 201 is 2 and the number of transitions of the additional transition link 202 is 1, and thus N=3 is given, so that “Peripheral Search [Reference=?, Genre=?]” is extracted as the upper-level hierarchical intention that satisfies the condition. Then, processing moves to Step ST52, and because of “NO”, processing further moves to Step ST53. This provides “YES” because the main intention of the upper-level hierarchical intention is “Peripheral Search” that is common. Then, processing moves to Step ST54, so that the transition destination in the upper hierarchical intention is replaced with changed data, as shown in the additional transition link 203.

When the transition destination is thus replaced, this results in that the intention transition destination of the additional transition link 203 is changed to the intention node 211 in FIG. 21. Accordingly, thereafter, when the user makes an utterance with the intention of “Route Selection [Type=?]” followed by making an utterance corresponding to the intention node 213 (for example, “Search a shop near the destination”), the dialog management system executes the transition to the intention node 213 without making confirmation. Thus, it is possible to reach a command without making useless dialog.

As described above, according to the dialog management system of Embodiment 3, it includes a transition controller that, when the intention determined by the transition node determination processor is associated with a transition to an unexpected intention out of a link defined by the hierarchical intentions, adds information of a link from a corresponding transition source to a corresponding transition destination; wherein the transition node determination processor treats the link added by the transition controller similarly like a normal link, to thereby determine the intention. Thus, it is possible to perform an appropriate transition even for an unexpected input, to thereby execute an appropriate command.

Further, according to the dialog management system of Embodiment 3, when there is a plurality of transitions to the unexpected intentions and the plurality of unexpected intentions has a common intention, as a parent node, the transition controller replaces the transition to the unexpected intention with a transition to the parent node.

Thus, it is possible to execute a desired command with reduced dialog.

Note that in Embodiments 1 to 3, although the description has been made using Japanese language, it can be applied to the cases of a variety of languages in English, German, Chinese and the like, by changing the extraction method of the feature related to intention estimation for each of the respective languages.

Further, in the case of the language whose word is partitioned by a specific symbol (a space, etc.), when its linguistic structure is difficult to be analyzed, it is also allowable to take such a manner that a natural language text as an output is subjected to extraction processing of $Facility$, $Residence$ and the like, using a pattern matching or like method, and thereafter, intention estimation processing is directly executed.

Furthermore, in Embodiments 1 to 3, the description has been made assuming that the input is a speech input; however, even in the case of a text input using an input means, such as a keyboard, without using speech recognition as an input method, a similar effect can be expected.

Furthermore, in Embodiments 1 to 3, intention estimation has been performed by subjecting a text, as a speech recognition result, to processing by the morphological analyzer; however, in the case where a result by the speech recognition engine includes itself a morphological analysis result, intention estimation can be performed directly using its information.

Furthermore, in Embodiments 1 to 3, although the description about a method of intention estimation has been made using an example to which a learning model by a maximum entropy method is assumed to be applied, the method of intention estimation is not limited thereto.

It should be noted that unlimited combination of the respective embodiments, modification of any element in the embodiments and omission of any element in the embodiments may be made in the present invention without departing from the scope of the invention.

### INDUSTRIAL APPLICABILITY

As described above, the dialog management system and the dialog management method according to the invention relate to such a configuration in which a plurality of dialog scenarios each constituted in a tree structure is prepared beforehand and transition is performed from a given one of the scenarios in a tree structure to another one of the scenarios in a tree structure, on the basis of dialog with the user; and are suited to be used as/for a speech interface in a mobile phone or a car-navigation system.

### DESCRIPTION OF REFERENCE NUMERALS and SIGNS

1: speech input unit, 2: dialog management unit, 3: speech output unit, 4: speech recognizer, 5: morphological analyzer, 6: intention estimation model, 7: intention estimation processor, 8: intention hierarchical graphic data, 9: intention estimated-weight determination processor, 10: transition node determination processor, 11: dialog scenario data, 12: dialog history data, 13: dialog turn generator, 14: speech synthesizer, 15: command history data, 16: history-considered dialog turn generator, 17: additional transition-link data, 18: transition link controller.

1-6. (canceled)

7. An dialog control system comprising:
an intention estimation processor that, based on data provided by converting an input in a natural language into a morpheme string, estimates an intention of the input;
an intention estimated-weight determination processor that, based on data in which intentions are arranged in a hierarchical structure and based on the intention thereamong being activated at a given object time, determines an intention estimated weight of the intention estimated by the intention estimation processor;
a transition node determination processor that determines an intention to be newly activated through transition, after correcting an estimation result by the intention estimation processor according to the intention estimated weight determined by the intention estimated-weight determination processor;
a history-considered dialog turn generator that generates a turn of dialog from one or plural intentions activated by the transition node determination processor, and that records each command having been executed as a result by the dialog, to thereby generate a turn of dialog using a list in which selectable intentions in a history of executed commands are registered when, among the intentions, the intention other than the intention having been subjected to execution is thereafter subjected to execution within a specified time period; and
an dialog manager that, when a new input in the natural language is provided due to the turn of dialog generated by the history-considered dialog turn generator, controls at least one process among processes performed by the intention estimation processor, the intention estimated-weight determination processor, the transition node determination processor and the history-considered dialog turn generator, followed by repeating that controlling, to thereby finally execute a setup command.

8. The dialog control system of claim 7, wherein, when, among the selectable intentions in the history of executed commands, an intention other than the intention having been subjected to execution is thereafter subjected to execution within a predetermined time period, the history-considered dialog turn generator generates a turn of dialog for making confirmation; and
wherein, after generation of said turn of dialog, when, among the selectable intentions being present in the list, the intention other than the intention having been subjected to execution is not subjected to execution within a predetermined time period, and this condition is repeated a setup number of times, the history-considered dialog turn generator deletes the list and stops generation of said turn of dialog for making confirmation.

9. The dialog control system of claim 7, which includes a transition link controller that, when the intention determined by the transition node determination processor is associated with a transition to an unexpected intention out of a link defined by hierarchical intentions, adds information of a link from a corresponding transition source to a corresponding transition destination;
wherein the transition node determination processor treats the link added by the transition link controller similarly like a normal link, to thereby determine an intention to be subjected to transition.

10. The dialog control system of claim 9, wherein, when there are a plurality of transitions toward unexpected intentions, each being said unexpected intention, and the plurality of unexpected intentions has a common intention as a parent node, the transition controller replaces a transition to each of the unexpected intentions with a transition to the parent node.

11. An dialog control method using an dialog control system that estimates an intention of an input in a natural language to perform dialog and, as a result, to execute a setup command, comprising:
an intention estimation step of estimating the intention of the input, based on data provided by converting the input in the natural language into a morpheme string;
an intention estimated-weight determination step of determining, based on data in which intentions are arranged in a hierarchical structure and based on the intention thereamong being activated at a given object time, an intention estimated weight of the intention estimated in the intention estimation step;
a transition node determination step of determining an intention to be newly activated through transition, after correcting an estimation result in the intention estimation step according to the intention estimated weight determined in the intention estimated-weight determination step;
a history-considered dialog turn generation step of generating a turn of dialog from one or plural intentions activated in the transition node determination step, and that records each command having been executed as a result by the dialog, to thereby generate a turn of dialog using a list in which selectable intentions in a history of executed commands are registered when, among the intentions, the intention other than the intention having been subjected to execution is thereafter subjected to execution within a specified time period; and
an dialog control step of controlling, when a new input in the natural language is provided due to the turn of dialog generated in the history-considered dialog turn generation step, at least one step among the intention estimation step, the intention estimated-weight determination step, the transition node determination step and the history-considered dialog turn generation step, followed by repeating that controlling, to thereby finally execute a setup command.
